(19) United States
(12) Patent Application Publication
(10) Pub. No.: US 2025/0020499 A1
(43) Pub. Date: Jan. 16, 2025

(54) DEVICE FOR THE INDIRECT MEASUREMENT OF THE FILL LEVEL OF A PRESSURIZED LIQUID IN A FLUID CONTAINER AND METHOD

(71) Applicant: BLANCO GMBH + CO KG, Oberderdingen (DE)

(72) Inventors: Thomas ZÖLLNER, Wuppertal (DE); Kay SCHMIDT, Flehingen (DE)

(73) Assignee: BLANCO GMBH + CO KG, Oberderdingen (DE)

(21) Appl. No.: 18/769,643

(22) Filed: Jul. 11, 2024

(30) Foreign Application Priority Data
Jul. 14, 2023 (DE) 10 2023 206 710.2

(51) Int. Cl. G01F 23/22; G01F 23/14; G01K 3/10

(52) U.S. Cl. CPC G01F 23/22; G01F 23/14; G01K 3/10

(57) ABSTRACT

The invention relates to a device for indirectly measuring the level of a pressurized liquid in a fluid container, in particular in the form of a liquefied gas container, comprising a connecting piece and/or a line piece connectable to the connecting piece, wherein the connecting piece and/or the line piece can be connected to a connection of the fluid container and with which gas can be removed from the fluid container, wherein the connecting piece and/or the line piece has a fluid channel on or in which at least one temperature sensor for measuring the temperature of a fluid in the fluid channel is arranged, and a fill level detection device that is connected to the temperature sensor and which is designed to measure the temperature curve of the removed fluid in the fluid channel by means of at least one temperature sensor over a predeterminable period of time during the removal process from the fluid container and to determine the fill level of the liquid in the fluid container based on the measured temperature curve.

The invention relates to a device for indirectly measuring the fill level of a pressurized liquid in a fluid container.

The invention further relates to a method for indirectly measuring the fill level of a pressurized liquid in a fluid container.

The invention further relates to a fluid system comprising a device for indirectly measuring the fill level of a pressurized liquid in a fluid container and a fluid container.

Although generally applicable to any fluids, in particular liquefied gases, the present invention is explained with reference to CO₂ liquefied gas containers.

CO₂ cartridges or liquefied gas containers are used in kitchens, for example, to carbonate water in order to produce “sparkling water”. For this purpose, they are connected to a corresponding line for a carbonization unit in a base cabinet. These can then be dispensed by a user using a corresponding sanitary fitting. The CO₂ liquefied gas container usually contains liquid CO₂.

Since the CO₂ liquefied gas containers for the kitchen area have to be changed frequently—depending on usage behavior—it is important for a user to know the current fill level. To determine the fill level, it has become known to determine the remaining liquid CO₂ based on a consumption known from tests, taking into account a safety reserve. The disadvantage, however, is that the CO₂ container is displayed to the user as “empty” even though it still contains CO₂. A further disadvantage is that when using a new but only partially filled container, the level is determined to be too high, so that the CO₂ liquefied gas container is already empty, although the display shows that the container is still partially full. This is frustrating for a user, as he or she is often unable to get a replacement in time. For liquefied gas containers in other areas of application, acoustic measurements, as well as temperature measurements on the container wall and weight measurements are used.

Weight measurement is mainly used in filling plants but is disadvantageous in the kitchen area due to the costs and mechanical effort.

An acoustic measurement has the particular disadvantage that the acoustic probe must be pressed very tightly against the container wall for sufficient acoustic coupling. A further disadvantage is that such a measurement can only indicate whether there is still liquid or gas in the container at the measured point. For a display with several intermediate steps/fill levels, several probes are therefore necessary. The acoustic measurement also has the disadvantage that, due to its principle, it delivers inaccurate measurement results with aluminum containers and with small volumes. Also, the acoustic probe must be placed directly on the surface of the metal container. Stickers and films interfere with the acoustic measurement, making this method unsuitable for the small liquefied gas containers commonly used in households or kitchens.

The thermal measurement on the flat outer wall can also only indicate at specific points whether liquid or gas is contained at the measuring point. A further disadvantage is that a measurement can only be carried out if sufficient gas is removed, as the container must cool down noticeably as a result of the removal. Here, a good connection of the temperature sensor to the outer wall is also necessary.

Other known devices and methods are known, for example, from U.S. Pat. No. 3,161,050 A or CN 107218983 A.

An objective of the present invention is therefore to provide a more accurate, cost-effective and at the same time more flexible device for determining the fill level of a fluid container, which enables a higher user satisfaction, as well as a corresponding method. A further objective of the present invention is to provide an alternative device for determining the fill level of a fluid container, an alternative fluid system and an alternative method for determining the fill level of a fluid container.

In one embodiment, the present invention achieves the above-mentioned objectives with a device for indirectly measuring the level of a pressurized liquid in a fluid container, in particular in the form of a liquefied gas container, comprising a connecting piece and/or a line piece connectable to the connecting piece, wherein the connecting piece and/or the line piece can be connected to a connection of the fluid container and with which gas can be removed from the fluid container, wherein the connecting piece and/or the line piece has a fluid channel on or in which at least one temperature sensor for measuring the temperature of a fluid in the fluid channel is arranged, and
a fill level detection device that is connected to the temperature sensor and which is designed to measure the temperature curve of the removed fluid in the fluid channel by means of at least one temperature sensor over a predeterminable period of time during the removal process from the fluid container and to determine the fill level of the liquid in the fluid container based on the measured temperature curve.

In one embodiment, the present invention achieves the above-mentioned objectives with a method for indirectly measuring the level of a pressurized liquid in a fluid container, comprising the steps
providing a connecting piece and/or a line piece connected to the connecting piece with a fluid channel on or in which at least one temperature sensor for measuring the temperature of a fluid in the fluid channel is arranged,
connecting the connecting piece and/or the line piece to an outlet of the fluid container,
removing a quantity of gas from the fluid container,
determining a temperature curve over a predeterminable period of time of the extracted gas by means of at least one temperature sensor, and
determining the level of the liquid in the fluid container based on the measured temperature curve.

In one embodiment, the present invention achieves the above-mentioned objective with a fluid system comprising a device for indirectly measuring the fill level of a pressurized liquid in a fluid container according to one of claims 1-8 and a fluid container that can be connected to the connecting piece and/or the line piece of the device.

One of the advantages achieved is that it can be used to reliably measure the fill level in a fluid container, in particular in the form of a liquefied gas container. A further advantage is that the sensor does not have to be placed directly on, in or on top of the container, but downstream of the opening of the container, which allows the fluid container to be easily replaced. Another advantage is that user satisfaction is significantly improved, particularly due to the more accurate measurement and more reliable display of the fluid container level.

The term “fluid” is to be understood in the broadest sense and refers, in particular in the claims, preferably in the description, to a liquid, a liquid mixture, a gas, a gas mixture or combinations thereof.

The term “cartridge” is to be understood in the broadest sense and refers, in particular in the claims, preferably in the description, to any type of container for holding one or more fluids, which is in particular arranged to be exchangeable.

The term “sanitary” is to be understood in the broadest sense and refers, in particular in the claims, preferably in the description, generally to the kitchen area, the bathroom or laundry room area and the heating area.

Further features, advantages and further embodiments of the invention are described below or will become apparent thereby.

In a preferred embodiment, at least one further, in particular two further sensors, are arranged at different positions along the fluid channel. The advantage of this is that a more precise measurement of the temperature curve can be carried out at different locations so that the overall measurement accuracy is increased.

In another preferred embodiment, the connecting piece is designed as a pressure reducer. The advantage of this is that a user does not have to buy and arrange an additional component, but that an integrated component, which a user usually has to use, already has the corresponding sensors for determining the fill level. This also increases user satisfaction.

In another preferred embodiment, a temperature sensor is arranged at the inlet and outlet of the pressure reducer. The advantage of this is that it is possible to determine the fill level using sensors in the pressure reducer in a simple and at the same time particularly reliable manner, without changing the basic structure of the pressure reducer.

In another preferred embodiment, the fill level detection device is designed to determine the fill level based on the withdrawal quantity of the fluid. One of the advantages achieved is that it allows for even more precise level determination. If a defined withdrawal quantity is specified, the temperature drop can be determined in a particularly reliable manner with the withdrawal quantity on the one hand and the fill level on the other. In addition, a previous fill level can be determined based on previous withdrawals and the current fill level can then be determined based on this.

In another preferred embodiment, a display device, in particular an optical one, is arranged, which is designed to display the fill level at least in 25% steps, in particular at least in 20% steps, preferably at least in 10% steps, between 0% and 100%, and which is connected to the fill level detection device, in particular wirelessly. The advantage of this is that the user has a sufficient fill level indicator so that he or she can purchase a new filled fluid container in good time. If a wireless connection is used, the laying of cables, etc. can be largely avoided.

In another preferred embodiment, at least the connecting piece and/or the line piece are made of plastic. The advantage of this is cost-effective production and easy integration of one or more temperature sensors.

In another preferred embodiment, a fluid container change can be detected by means of the fill level detection device, in particular by detecting a pressure drop at the connecting piece and/or line piece. The advantage of this is that the detection device automatically discards the previously determined fill level and determines the fill level as soon as liquid gas is tapped.

In another preferred embodiment, a temperature drop within the predeterminable time period is measured to determine the fill level. This enables simple and reliable determination of the fill level of the fluid container.

In another preferred embodiment, in order to determine the fill level, a comparison is made with previously determined comparison curves which represent different fill levels. One of the advantages achieved is that the fill level can be determined in a particularly simple and reliable manner.

In another preferred embodiment, in order to determine the fill level, the time until a temperature drop of at least 0.5 degrees Celsius, in particular at least 1.0 degrees Celsius, preferably at least 2.0 degrees Celsius, in particular at least 5.0 degrees Celsius is determined, measured since the gas extraction began. The advantage of this is that any heated gas cushions can be removed and at the same time it can be determined how long it takes until a significant drop in temperature occurs due to the gas expansion during removal, which provides additional information for the previous fill level.

In another preferred embodiment, the ambient temperature of the fluid container is determined, and the fill level is determined by means of the determined ambient temperature. In this way, a measured temperature curve can be compared to the ambient temperature so that, for example, a small temperature drop at a higher ambient temperature can be determined more precisely and this can be compensated for or the measured temperature curve can be standardized to a predefined temperature.

In another preferred embodiment, the temperature curve is only determined after a predeterminable period of time. This saves energy so that no measurement is taken while there is an already heated gas cushion in the connecting piece and/or line piece.

Further important features and advantages of the invention result from the sub-claims, from the drawings and from the associated description of the figures with reference to the drawings.

It is understood that the above-mentioned features, and features yet to be explained below, may be used not only in the respectively indicated combination, but also in other combinations or alone, without departing from the scope of the present invention.

Preferred designs and embodiments of this invention are shown in the accompanying drawings and are explained in more detail in the following description, wherein identical reference numbers refer to identical or similar or functionally identical components or elements.

In the form of a diagram,

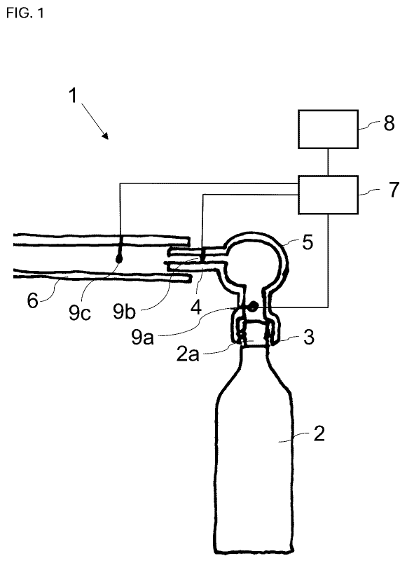

FIG. 1 shows a device according to an embodiment of the present invention;

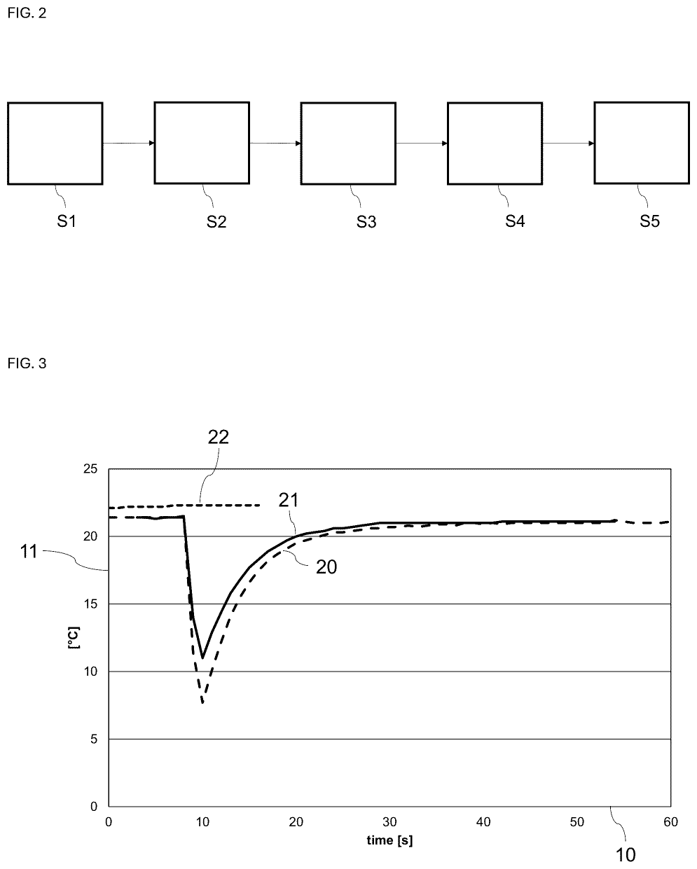

FIG. 2 shows the steps of a method according to an embodiment of the present invention; and

FIG. 3 shows a temperature-time diagram obtained with a device according to an embodiment of the present invention.

FIG. 1 shows a device for indirectly measuring the level of a pressurized liquid in a fluid container.

FIG. 1 shows a device 1 for indirectly measuring the fill level of liquid CO₂ in a fluid container, in particular a liquid gas cylinder in the form of a CO₂ gas cylinder 2. The gas cylinder 2 has an opening 2a for the removal of CO₂. The opening 2a is connected in a pressure-tight manner to connection 3 of a pressure reducer 5. An outlet 4 of the pressure reducer 5 is further connected to a line or pipe 6. A temperature measuring sensor 9a, 9b, 9c is arranged in the area of the connection 3, in the area of the outlet 4 and in the area of the outlet 4 in line 6. The temperature measuring sensors 9a, 9b, 9c are connected to a detection device 7, for example a microprocessor or the like. This in turn can have a display device 8 or be connected to such a device in a wired or wireless manner in order to display the fill level determined by the detection device 7 to a user, for example visually in 10% steps. The detection device 7 is a fill level detection device which is designed to measure the temperature curve of the extracted CO₂ gas in the fluid channel(s), here the fluid channel within the pressure reducer 5 from the inlet 3 to the outlet 4 and in the line 6, over a predeterminable period of time during the removal process from the CO₂ gas cylinder 2 by means of the temperature sensors 9a, 9b, 9c and to determine the level of the liquid CO₂ in the CO₂ gas cylinder 2 based on the measured temperature curve.

FIG. 2 shows the steps of a method according to an embodiment of the present invention.

FIG. 2 shows the steps of a method for indirectly measuring the level of a pressurized liquid in a fluid container. The method comprises the following steps
providing S1 a connecting piece 5 and/or a line piece 6 connected to the connecting piece 5, with a fluid channel at or in which at least one temperature sensor 9a, 9b, 9c is arranged for measuring the temperature of a fluid in the fluid channel,
connecting S2 of the connecting piece 5 and/or the line piece 6 to an outlet 3 of the fluid container 2,
removing S3 a quantity of gas from the fluid container 2,
determining S4 a temperature curve over a predeterminable period of time of the extracted gas by means of at least one temperature sensor 9a, 9b, 9c, and
determining S5 the fill level of the liquid in the fluid container 2 based on the measured temperature curve.

FIG. 3 shows a temperature-time diagram obtained with a device according to an embodiment of the present invention.

FIG. 3 shows a diagram which shows the measured temperature 11 as a function of time 10 when removing CO₂ from a CO₂ gas cylinder. The measured temperature curve of curve 20 corresponds to a CO₂ gas cylinder that is approximately ⅔ full, the measured temperature curve of curve 21 corresponds to a CO₂ gas cylinder that is approximately ⅓ full, and the measured temperature curve of curve 22 corresponds to a CO₂ gas cylinder that is almost empty.

The measured temperature curve can be explained as follows. The gas under pressure in a fluid container, for example a compressed gas cylinder, cools down considerably when it is removed, i.e. when it changes from the liquid to the gaseous phase. In order to be able to detect the pressure even when small quantities are withdrawn, the corresponding temperature sensor for measuring the temperature of the CO₂ gas can be arranged as close as possible to the outlet on the compressed gas cylinder. The temperature sensor can, for example, be arranged in and/or directly after a pressure reducer, as described in FIG. 1. It is also possible to arrange only one temperature sensor and not several along the compressed gas cylinder wall as is the case with known fill level detection devices. Since the temperature sensor in or after the pressure reducer is outside the area to be serviced by the user, its handling and arrangement are significantly less prone to errors.

With each extraction, a corresponding amount of CO₂ changes from liquid to gaseous state. This requires energy, which is first taken from the medium, i.e. the liquid CO₂ itself. This causes the surface of the liquid CO₂ to cool down. Since liquid CO₂ conducts heat better than gaseous CO₂, the energy is initially taken primarily from the liquid part. If there is still a lot of liquid CO₂ in the cylinder, only a small gaseous cushion is present. The temperature at the outlet of the CO₂ gas cylinder will therefore drop quickly. If there is only a little liquid CO₂ left in the cylinder, the CO₂ gas cushion above the liquid/gas limit is significantly larger. It then takes longer for the temperature at the extraction point to drop because gas is generally a poor conductor of heat. This difference in temperature change, especially when the withdrawal quantity is known, can be used to determine the level of liquid CO₂ in the gas cylinder.

For this purpose, for example, the maximum of the temperature change (the minimum reached normalized to the starting value) or a measuring point at a specific time in the respective curves 20, 21, 22 can be used. Since this is a relative temperature measurement, the ambient temperature only plays a role insofar as it should be above the boiling point of the CO₂ gas.

Methods and devices according to embodiments of the invention can be used with any gases in containers which are present in liquid form in the cylinder and can be removed in portions or partially in gaseous form.

The temperature drop is greatest in curve 20 because—compared to the other two curves—there is still the most liquid CO₂ in the fluid container. Curve 21 also shows a strong drop in temperature, although not as strong as curve 20. In curve 22, there is almost no liquid CO₂ left in the fluid container, so that hardly any or no cooling, i.e. no drop in temperature, can be detected.

To determine the fill level, comparisons can now be made with comparison curves standardized to 0 degrees Celsius in particular. These can also be specified with regard to different withdrawal quantities. To determine the fill level, the comparison curves can also be interpolated in order to determine the fill level as accurately as possible.

As a result, the fill level can be precisely indicated to a user in 25% steps, 20% steps, 10% steps or even 5% steps.

In summary, at least one of the embodiments of the invention has at least one of the following advantages and/or provides at least one of the following features:
High level of user satisfaction.
Cost-effective production or implementation.
High level of flexibility.
Simple and quick measurement of the fill level with a high level of accuracy.
High level of reliability in determining the level of gas in fluid containers, especially compressed gas containers.

Although the present invention was described using preferred embodiments, it is not limited to these, but rather may be modified in various ways.

### LIST OF REFERENCE SIGNS

1 Device
2 CO₂ gas cylinder
2a Removal opening
3 Connector
4 Outlet
5 Connecting piece/pressure reducer
6 Line piece
7 Fill level detection device
8 Display device
9a, 9b, 9c Temperature sensor
10 Time in seconds
11 Temperature in ° C. Temperature curve
21 Temperature curve
22 Temperature curve
S1-S5 Steps of a method

1. A device for indirectly measuring the level of a pressurized liquid in a fluid container, in particular in the form of a liquefied gas container, comprising
a connecting piece and/or a line piece connectable to the connecting piece, wherein the connecting piece and/or the line piece is connectable to a connection of the fluid container whereby gas can be removed from the fluid container, wherein the connecting piece and/or the line piece has a fluid channel on or in which at least one temperature sensor is arranged for measuring the temperature of a fluid in the fluid channel, and
a fill level detection device which is connected to the temperature sensor and which is designed to measure the temperature curve of the removed fluid in the fluid channel by means of at least one temperature sensor over a predeterminable period of time during the removal process from the fluid container and to determine the fill level of the liquid in the fluid container based on the measured temperature curve.

2. The device according to claim 1, wherein at least one further, in particular two further, temperature sensors are arranged at different positions along the fluid channel.

3. The device according to claim 1, wherein the connecting piece is designed as a pressure reducer.

4. The device according to claim 1, characterized in that a temperature sensor is arranged at the inlet and outlet of the pressure reducer.

5. The device according to claim 1, wherein the fill level detection device is designed to determine the fill level based on a withdrawal amount of the fluid.

6. The device according to claim 1, wherein a display device, in particular an optical display device, is arranged, which is designed to display the fill level at least in 25% steps, in particular at least in 20% steps, preferably at least in 10% steps, between 0% and 100%, and which is connected to the fill level detection device, in particular wirelessly.

7. The device according to claim 1, wherein at least the connecting piece and/or the line piece are made of plastic.

8. The device according to claim 1, wherein a fluid container change can be detected by means of the fill level detection device, in particular by detecting a pressure drop at the connecting piece and/or line piece.

9. A method for indirectly measuring the level of a pressurized liquid in a fluid container, comprising the steps
Providing a connecting piece and/or a line piece connected to the connecting piece with a fluid channel on or in which at least one temperature sensor for measuring the temperature of a fluid in the fluid channel is arranged,
Connecting the connecting piece and/or the line piece to an outlet of the fluid container,
Removing a quantity of gas from the fluid container,
Determining a temperature curve over a predeterminable period of time of the extracted gas by means of at least one temperature sensor, and
Determining the fill level of the liquid in the fluid container based on the measured temperature curve.

10. The method according to claim 9, for determining the fill level, a temperature drop within the predeterminable time period is determined.

11. The method according to claim 9, wherein for determining the fill level, a comparison is made with previously determined comparison curves that represent different fill levels.

12. The method according to claim 9, wherein for determining the fill level, the time until a temperature drop of at least 0.5 degrees Celsius, in particular at least 1.0 degrees Celsius, preferably at least 2.0 degrees Celsius, in particular at least 5.0 degrees Celsius is determined, measured since the gas extraction began.

13. The method according to claim 9, wherein an ambient temperature of the fluid container is determined, and the fill level is determined by means of the determined ambient temperature.

14. The method according to claim 9, wherein the determination of the temperature curve only takes place after a predeterminable period of time.

15. A fluid system comprising a device for indirectly measuring the fill level of a pressurized liquid in a fluid container, in particular in the form of a liquefied gas container, according to claim 1 and a fluid container which can be connected to the connecting piece and/or the line piece of the device.
